(19) United States
(12) Patent Application Publication
(10) Pub. No.: US 2022/0355602 A1
(43) Pub. Date: Nov. 10, 2022

(54) IMAGE FORMATION WITH A CONCENTRATED INK MIXTURE

(71) Applicant: Hewlett-Packard Development Company, L.P., Spring, TX (US)

(72) Inventors: Omer Gila, Palo Alto, CA (US); Napoleon J. Leoni, Palo Alto, CA (US); Rajesh Kelekar, Palo Alto, CA (US); Dekel Green, Palo Alto, CA (US)

(73) Assignee: Hewlett-Packard Development Company, L.P., Spring, TX (US)

(21) Appl. No.: 17/764,611

(22) PCT Filed: Oct. 29, 2019
(86) PCT No.: PCT/US2019/058508

§ 371 Date: Mar. 29, 2022

(51) Int. Cl. B41M 5/00; B41J 2/41

(52) U.S. Cl. CPC B41M 5/0011; B41J 2/41

(57) ABSTRACT

An image formation device includes a mixer, a fluid ejection device, and a liquid removal element. The mixer is to receive a first ink mixture of ink particles within a first non-aqueous liquid carrier in a first concentration, to receive a second non-aqueous liquid carrier, and to form a second ink mixture of the ink particles within both the first and second liquid carriers in a second concentration less than the first concentration. The fluid ejection device is to receive the second ink mixture and to deposit droplets of the second ink mixture onto a substrate to at least partially form an image via the ink particles. The liquid removal element is to remove the respective liquid carriers from the substrate to provide at least a portion of the second liquid carrier at the mixer to form part of the second ink mixture.

### BACKGROUND

Modern printing techniques involve a wide variety of media, whether rigid or flexible, and for a wide range of purposes. In some printing techniques, ink may be provided in a concentrated form prior to its application to the media.

### BRIEF DESCRIPTION OF THE DRAWINGS

FIG. 1A is a diagram including a side view schematically representing an example image formation device.

FIG. 1B is a block diagram schematically representing an example mixer.

FIG. 2 is a block diagram schematically representing an example liquid removal element.

FIG. 3 is a diagram schematically representing an example image formation device including a liquid recovery arrangement.

FIG. 4 is a diagram schematically representing an example image formation device including a charge source for electrostatic fixation of ink particles.

FIG. 5 is a diagram schematically representing an example image formation device including a substrate in a roll-to-roll arrangement.

FIG. 6 is a diagram schematically representing an example image formation device including a substrate acting as an intermediate transfer member.

FIG. 7A is a diagram schematically representing an example image formation device including a scanning carriage.

FIG. 7B is a top view schematically representing an example scanning carriage of an image formation device.

FIG. 8A is a block diagram schematically representing an example print engine.

FIG. 8B is a block diagram schematically representing an example control portion.

FIG. 8C is a block diagram schematically representing an example user interface.

FIG. 9 is a flow diagram schematically representing an example method of image formation.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense. It is to be understood that features of the various examples described herein may be combined, in part or whole, with each other, unless specifically noted otherwise.

At least some examples of the present disclosure are directed to using concentrated inks, after dilution, in an image formation device. In some examples, an image formation device comprises a mixer to receive a first ink mixture of ink particles within a first non-aqueous liquid carrier in a first concentration, to receive a second non-aqueous liquid carrier, and to form a second ink mixture of the ink particles within both the first and second liquid carriers in a second concentration less than the first concentration. In some examples, the image formation device may comprise a drop-on demand fluid ejection device to receive the second ink mixture and to deposit droplets of the second ink mixture onto a substrate to at least partially form an image via the ink particles. In some examples, the image formation device may comprise a liquid removal element to remove the respective liquid carriers (of the second ink mixture) from the substrate to provide at least a portion of the second liquid carrier at the mixer to form part of the second ink mixture.

In some examples, the image formation device may comprise a charge source to emit airborne charges to induce the ink particles of the deposited droplets to move through the respective first and second liquid carriers (of the deposited droplets) to become electrostatically fixed relative to the substrate.

In some examples, the image formation device may comprise a scanning-type printer. In some such examples, the image formation device may omit cold oil removal, such as mechanical removal of the liquid carrier. In some such examples, the substrate may comprise a cloth or textile material.

In one aspect, by providing the first ink mixture to the image formation device in a concentrated form, may significantly decrease the overall operational cost of the image formation device at least because up to 50 percent of the overall operational cost may comprise the cost of packaging, shipping, handling, etc. the ink. Accordingly, by the image formation device receiving the ink mixture in a concentrated form, one may significantly decrease the volume of ink being packaged, shipped, etc., and thereby reduce the overall cost. In addition to this cost savings, the example image formation device may recover and re-use liquid carriers of the ink to dilute the concentrated ink mixture, which further reduces overall operational costs while lessening the environmental impact.

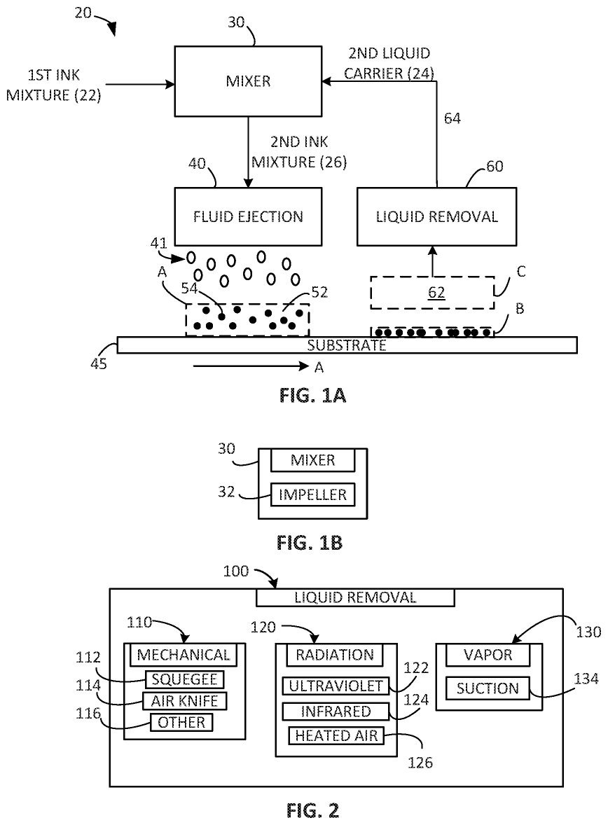

These examples, and additional examples, are further described below in association with at least FIGS. 1A-9.

As shown in FIG. 1A, in some examples an image formation device 20 may comprise a mixer 30, a fluid ejection device 40, and a liquid removal element 60. In some examples, the mixer 30 is to receive a first ink mixture 22 of ink particles within a first non-aqueous liquid carrier in a first concentration, to receive a second non-aqueous liquid carrier 24, and to form a second ink mixture 26 of the ink particles within both the first and second liquid carriers in a second concentration less than the first concentration. The first and second ink mixtures 22, 26 may sometimes be referred to as first and second liquid ink mixtures and/or as first and second non-paste ink mixtures.

As shown in FIG. 1A, in some examples one aspect of image formation comprises the drop-on demand fluid ejection device 40 receiving the second liquid ink mixture 26 and depositing droplets 41 of the second liquid ink mixture 26 onto a substrate 45 to at least partially form an image via the ink particles 54 within the second liquid ink mixture 26. As depicted within the dashed lines A in FIG. 1A, deposited droplets 41 result in ink particles 54 being suspended within liquid carrier 52 on substrate 45, with ink particles 54 having a location and/or spacing which begins to form at least a portion of an image on substrate 45. As previously noted, the liquid carrier 52 comprises some liquid carrier from the first ink mixture 22 and some liquid carrier from the second liquid carrier 24. In some examples, the droplets 41 may comprise pigments (e.g. ink particles 54), dispersants, the carrier fluid 52, and may comprise additives such as bonding polymers.

During this depositing of droplets 41 (FIG. 1A), relative movement between the substrate 45 and the various elements (e.g. fluid ejection device 40) of the image formation device 20 occurs. The relative movement may comprise the substrate 45 moving relative to the fluid ejection device 40, may comprise the fluid ejection device 40 moving relative to the substrate 45, or both the fluid ejection device 40 and substrate 45 moving relative to each other.

In some examples, the fluid ejection device 40 comprises a drop-on-demand fluid ejection device. In some examples, the drop-on-demand fluid ejection device comprises an inkjet printhead. In some examples, the inkjet printhead comprises a piezoelectric inkjet printhead. In some examples, the fluid ejection device 40 may comprise other types of inkjet printheads. In some examples, the inkjet may comprise a thermal inkjet printhead. In some examples, the droplets may sometimes be referred to as being jetted onto the media. With this in mind, at least some of the aspects and/or implementations of image formation according to at least some examples of the present disclosure may sometimes be referred to as “jet-on-media”, “jet-on-substrate”, “jet-on-blanket”, “offjet printing”, and the like.

It will be understood that in some examples, the fluid ejection device 40 may comprise a permanent component of image formation device 20, which is sold, shipped, and/or supplied, etc. as part of image formation device 20. It will be understood that such “permanent” components may be removed for repair, upgrade, etc. as appropriate. However, in some examples, fluid ejection device 40 may be removably received, such as in instances when fluid ejection device 40 may comprise a consumable, be separately sold, etc.

In some examples, substrate 45 comprises a metallized layer or foil to which a ground element GND is electrically connected.

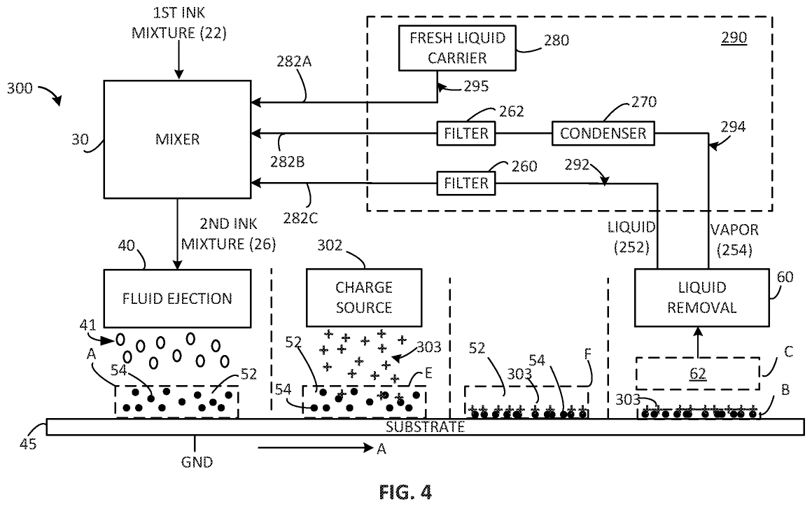

However, in some examples, the substrate is not metallized and comprises no conductive layer. In this case, an electrically conductive element separate from the substrate 45 is provided to contact the substrate 45 in order to implement grounding of the substrate 45. At least some further details regarding the grounding of the substrate 45 are described later in association with at least FIG. 4.

Through further relative movement of the substrate 45 (e.g. along direction A) relative to the image formation device 20, additional aspects of image formation are performed on or relative to substrate 45 following the operation of fluid ejection device 40 depicted in FIG. 1A.

For instance, with continued relative movement between substrate 45 and the image formation device 20, one further aspect of the example image formation comprises operation of a liquid removal element 60, as depicted in FIG. 1A. In particular, the liquid removal element 60 is to remove at least a portion 62 (shown in dashed lines) of the respective liquid carriers of the second ink mixture 26 (from deposited droplets 41) from the substrate 45 to provide at least a portion of the second liquid carrier 24 at the mixer 30 to form part of the second ink mixture 26. This removal may result in ink particles 54 remaining on substrate 45 in their targeted location to at least partially form the desired image. In some examples, this removal may comprises removing about 90 percent of the liquid on the substrate 45.

Various example implementations of liquid removal element 60 are described below in association with at least FIG. 2.

In some examples, the first liquid ink mixture 22 may comprise a liquid carrying from about 5 percent to about 50 percent solids by weight. In some examples, the liquid may carry from 10 percent to 40 percent solids by weight. In some examples, the solids may comprise ink particles 54 (e.g. pigments) and resins (e.g. binders, polymers, and the like). A relative proportion of the ink particles 54 and other solids (e.g. resins) may vary among different examples, with the relative proportion depending on factors such as the type of substrate (absorbing, non-absorbing), whether the resin is dissolvable or dispersable, desired color, opacity, pigment efficiency, type of pigment, etc.

In some examples, the first liquid ink mixture 22 may sometimes be referred to as a non-paste ink mixture.

In some examples in which the liquid of the second liquid ink mixture 26 carries about 6 percent solids by weight, this arrangement may correspond to about 3 percent solids by volume. In some of these examples, the solids may comprise mostly ink particles 54, such as pigments. In such examples of the second liquid ink mixture 26, this desired concentration may be achieved by starting with a first ink mixture 22 which has a higher concentration, which is then mixed with a liquid carrier 24 to achieve the desired concentration of solids of about 3% by volume to achieve the desired thickness of solids (e.g. ink particles) upon final drying of the substrate 45. In some of these examples, the first ink mixture 22 (which is to be diluted) may comprise 20 percent solids by weight and about 11 percent solids by volume, wherein the solids may comprise a majority of ink particles 54 (e.g. pigments) and a minority of other solids, such as binders or resins. In some of these examples, the second liquid ink mixture 26 may be deposited as droplets 41 having a 12 picoliter-per-droplet volume and at 600 dots-per-inch (dpi) resolution. In some such examples, this example deposition may result in a 7 micron thickness of the second liquid ink mixture 26 (e.g. 3% by volume solids) in a solid area of image formation, which may be expressed as about 7 grams-per-square meter (gsm) of the second liquid ink mixture 26. In at least this context, the term “solid area” may correspond to a portion of the substrate intended to have 100 percent coverage area of solidified ink on the substrate. After drying, this arrangement may produce some examples in which a solid area of a formed image on substrate 45 may comprise a thickness of 200 nanometers.

In some of the previously described examples of dilution of a high concentration first liquid ink mixture 22 to a lower concentration second liquid ink mixture 26, a density of ink particles (e.g. pigments) within the second liquid ink mixture 26 may comprise 1.5 gram/cm3 and a density of binders (e.g. resins) within the second liquid ink mixture 26 may comprise about 1 gram/cm3. It will be understood that the ink particles 54 and the binders within the second liquid ink mixture 26 may comprise all or substantially all (e.g. at least 95 percent) of the solids within the second liquid ink mixture. Accordingly, in such examples, the ink particles 54 (e.g. pigments) may comprise a majority of the solids within the second liquid ink mixture 26, and may comprises a majority of the solids within a solidified ink mixture on the substrate 45 after drying.

In some examples in which a resin R 135 is dispersed such that resin (e.g. binders) encapsulates each ink particle 134, the resin R 135 may comprise 1-6 times the volume of the ink particles 134. In some such examples, the encapsulation may be achieved as an emulsion.

In some examples, the concentration of the first liquid ink mixture 22 depends on the amount of liquid carrier that can be recovered from the image via the liquid removal element 60 (e.g. such mechanical removal, evaporative removal, etc.) and/or depend on the desired ink concentration desired to print a new image.

In some examples, the liquid forming part of the first liquid ink mixture 22 may comprise a non-aqueous fluid, which in some examples may comprise a low viscosity, dielectric oil, such as an isoparaffinic fluid. Some versions of such dielectric oil may be sold under the trade name Isopar®.

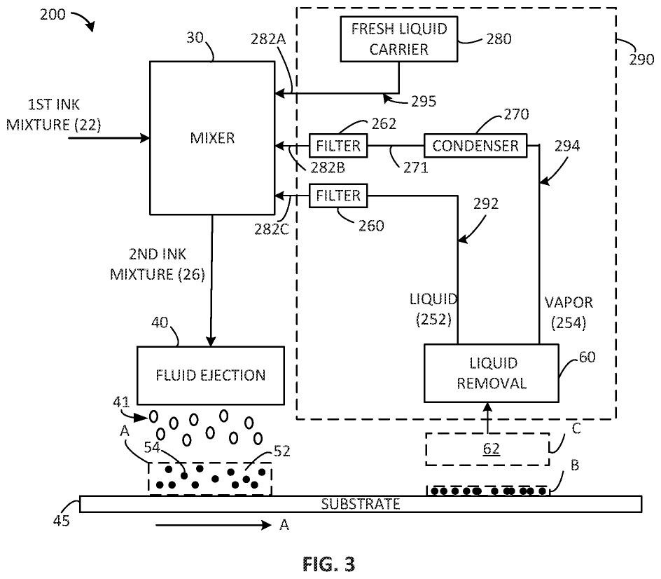

Upon receipt within the mixer 30, the first liquid ink mixture 22 is diluted with a non-aqueous liquid carrier 24. As further described later in association with at least FIG. 3, the liquid carrier 24 may be fresh liquid carrier and/or may be recycled liquid carrier. As noted below, the dilution may involve adding from about 20 percent to about 50 percent liquid (as the second liquid carrier 24) to the first liquid ink mixture 22.

In one aspect, the second liquid ink mixture 26 has a second concentration less than the first concentration of the first liquid ink mixture 22.

In some such examples, the concentration may be defined as a percent by weight of pigment within the respective first or second liquid ink mixture.

In some such examples, the second concentration is substantially less than the first concentration. Accordingly, in some such examples, with regard to a difference between the first concentration and the second concentration, the term “substantially less” comprises a 50 percent difference. In some examples, the term “substantially less” may comprise about 45 percent difference, about 35 percent difference, about 30 percent difference, about 25 percent difference.

In general terms, the amount or volume by which the first liquid ink mixture 22 may be diluted may vary depending upon the type of substrate and/or other factors like the pigment efficiency, color gamut, etc. In some examples, such as when the substrate is a cloth or textile material, the first liquid ink mixture 22 may have the following example composition as shown in Table 1.

TABLE 1

| Component | Weight | Volume |
|---|---|---|
| Oil | 0.16 kg | 0.21 L |
| Resin | 0.80 kg | 0.72 L |
| Pigment | 0.11 kg | 0.07 L |
| Total | 1.06 kg | 1.00 L |

Upon dilution of the first liquid ink mixture 22 via mixer, the second liquid ink mixture 26 may have the following example normalized composition as shown below in Table 2.

TABLE 2

| Component | Weight | Volume |
|---|---|---|
| Oil | 0.44 kg | 0.57 L |
| Resin | 0.44 kg | 0.40 L |
| Pigment | 0.05 kg | 0.03 L |
| Total | 0.93 kg | 1.00 L |

Accordingly, as taken from Tables 1 and 2, in some such examples, the first liquid ink mixture 22 may comprise about 11 percent pigment by weight, wherein the pigment corresponds to ink particles 54. In general terms, both the resin and the pigments are considered solids and the oil (e.g. non-aqueous liquid carrier) is considered a liquid. Upon dilution of the first liquid ink mixture 22 by the second liquid carrier 24, via the mixer, the second liquid ink mixture 26 may comprise about 6 percent pigment by weight. In some such examples, the solids such as resins may dissolved within the liquid carrier of the first and second liquid ink mixtures 22, 26. In some such examples, the resins may be dispersed within the liquid carrier of the first and second liquid ink mixtures 22, 26.

It will be understood that the example represented by Tables 1 and 2 is merely illustrative and not limiting regarding substrates comprising cloth or textile materials, and is not limiting regarding substrates made of materials other than cloth or textiles.

In some examples regarding the general arrangement of FIG. 1A, the first ink mixture comprises ink particles (e.g. pigment), a dispersant, and the liquid carrier. In some such examples, the ink particles, dispersant and the liquid carrier comprise the sole components of the first liquid ink mixture 22. Accordingly, in such examples, the first liquid ink mixture 22 omits (i.e. is without) a resin or other binder additives, which may be provided separately and/or later as desired to form at least part of the second liquid ink mixture 26.

In some examples, the mixer 30 comprises an impeller 32 within a chamber, such as shown in FIG. 1B. In some such examples, the impeller 32 comprises the sole mechanical element within the mixer 30 for mixing the first liquid ink mixture 22 with the second liquid carrier 24 to produce the second liquid ink mixture 26. Accordingly, via the impeller 32 or other simple mechanisms, the mixer 30 may produce the second ink mixture 26 without high-shear-mechanical-based mixing and/or without deagglomeration of the ink particles 54.

In some examples, mixer 30 produces the second ink mixture 26 without a low-high-low concentration process. Stated differently, via the impeller 32 or other simple element(s), the mixer 30 is to perform a simple dilution which converts the higher concentration first liquid ink mixture to a lower concentration (i.e. diluted) second liquid ink mixture 26. This arrangement avoids the complexity and high amounts of voltage and/or energy involved in a low-high-low concentration process.

In some examples, mixer 30 produces the second ink mixture 26 using less than 10 J/milliliter of energy at least because of the omission of high-shear-mechanical-based mixing, which may involve large amounts of energy such as substantially greater than 10 J/milliliter of energy. In some such examples, the term “substantially greater” comprises an order of magnitude difference.

In some examples, the substrate 45 comprises a non-absorbing material, non-absorbing coating, and/or non-absorbing properties. Accordingly, in some examples the medium is made of a material which hinders or prevents absorption of liquids, such as a carrier fluid and/or other liquids in the droplets received on the medium. In one aspect, in some such examples the non-absorbing medium does not permit the liquids to penetrate, or does not permit significant penetration of the liquids, into the surface of the non-absorbing medium.

The non-absorbing example implementations of the substrate 45 stands in sharp contrast to some forms of media, such as paper, which may absorb liquid. The non-absorbing attributes of the substrate 45 may facilitate drying of the ink particles on the media at least because later removal of liquid from the media will not involve the time and expense of attempting to pull liquid out of the media (as occurs with absorbing media) and/or the time, space, and expense of providing heated air for extended periods of time to dry liquid in an absorptive media.

Via the example arrangements, the example device and/or associated methods can print images on a non-absorbing medium (or some other medium) with minimal bleeding, dot smearing, etc. while permitting high quality color on color printing. Moreover, via these examples, image formation on a non-absorbing medium (or some other medium) can be performed with less time, less space, and less energy at least due to a significant reduction in drying time and capacity. These example arrangements stand in sharp contrast to other printing techniques, such as high coverage, aqueous-based step inkjet printing onto non-absorbing medium for which bleeding, dot smearing, cockling, etc. may yield relatively lower quality results, as well as unacceptably high cost, longer times, etc. associated with drying.

In some such examples, the non-absorptive substrate 45 may comprise other attributes, such as acting as a protective layer for items packaged within the media. Such items may comprise food or other sensitive items for which protection from moisture, light, air, etc. may be desired.

With this in mind, in some examples the substrate 45 may comprise a plastic media. In some examples, the substrate 45 may comprise polyethylene (PET) material, which may comprise a thickness on the order of about 10 microns. In some examples, the substrate 45 may comprise a biaxially oriented polypropylene (BOPP) material. In some examples, the substrate 45 may comprise a biaxially oriented polyethylene terephthalate (BOPET) polyester film, which may be sold under trade name Mylar in some instances. In some examples, the substrate 45 may comprise other types of materials which provide at least some of the features and attributes as described throughout the examples of the present disclosure. For examples, the substrate 45 or portions of substrate 45 may comprise a metallized foil or foil material, among other types of materials.

In some examples, print substrate 45 comprises a flexible packaging material. In some such examples, the flexible packaging material may comprise a food packaging material, such as for forming a wrapper, bag, sheet, cover, etc. As previously mentioned for at least some examples, the flexible packaging materials may comprise a non-absorptive media.

In some examples, the image formation device may sometimes be referred to as a printer or printing device. In some examples in which a media is supplied in a roll-to-roll arrangement or similar arrangements, the image formation device may sometimes be referred to as a web press and/or the print medium can be referred to as a media web.

At least some examples of the present disclosure are directed to forming an image directly on a print medium, such as without an intermediate transfer member. Accordingly, in some instances, the image formation may sometimes be referred to as occurring directly on the print medium. However, this does not necessarily exclude some examples in which an additive layer may be placed on the print medium prior to receiving ink particles (within a carrier fluid) onto the print medium. In some instances, the print medium also may sometimes be referred to as a non-transfer medium to indicate that the medium itself does not comprise a transfer member (e.g. transfer blanket, transfer drum) by which an ink image is to be later transferred to another print medium (e.g. paper or other material). In this regard, the print medium may sometimes also be referred to as a final medium or a media product. In some such instances, the medium may sometimes be referred to as product packaging medium.

In some examples, the substrate 45 may sometimes be referred to as a non-transfer substrate, i.e. a substrate which does not act as a transfer member (e.g. a member by which ink is initially received and later transferred to a final substrate bearing an image). Rather, in some such examples, the substrate 45 may comprise a final print medium such that the printing or image formation may sometimes be referred as being direct printing because no intermediate transfer member is utilized as part of the printing process.

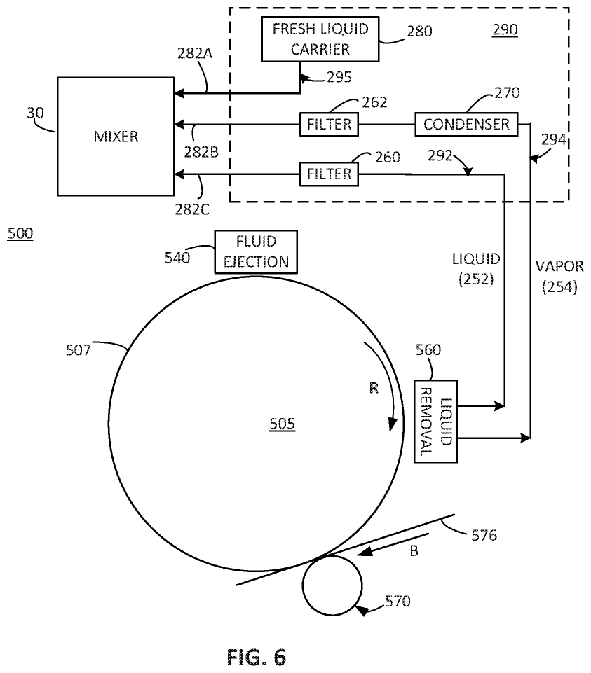

In some examples, the substrate 45 comprises an intermediate transfer member, such as (but not limited to) the example image formation device 500 further described in association with at least FIG. 6. In some instances, such intermediate transfer member may be referred to as a blanket.

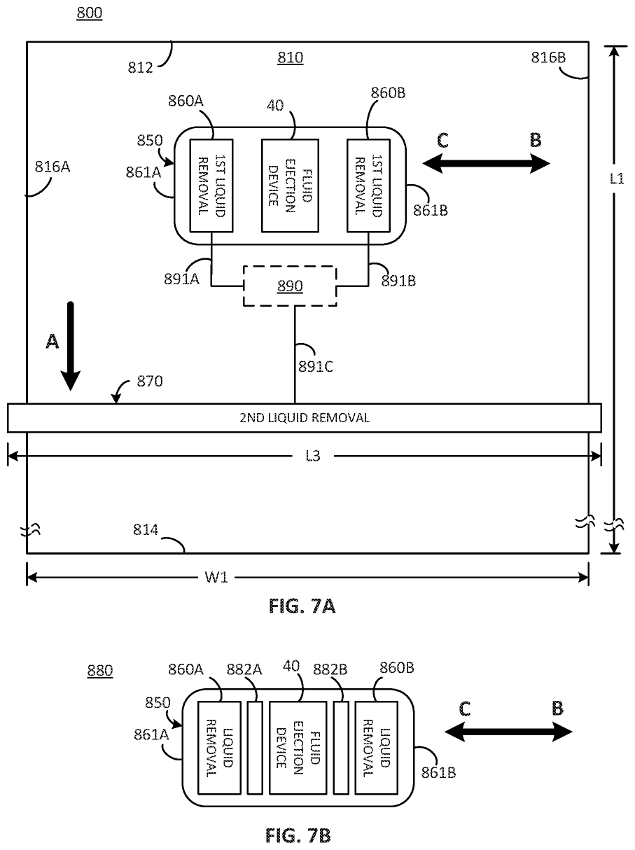

In some examples, the substrate 45 may comprise a cloth or textile material. At least some aspects of an example image formation device of the present disclosure, when the substrate 45 is a cloth or textile material, are further described in association with at least FIGS. 7A-7B.

FIG. 2 is a block diagram schematically representing various implementations of an example liquid removal element 100. In some examples, the liquid removal element 100 may comprise at least some of substantially the same features and attributes as liquid removal element 60 in FIG. 1A and/or may comprise one example implementation of liquid removal element 60 in FIG. 1A. As shown in FIG. 2, liquid removal element 100 may comprise a mechanical liquid removal element 110 to mechanically remove excess liquid (e.g. liquid carrier 52) from the substrate 45, which in some instances may be performed with little heating or no heating. As such, this type of liquid removal may sometimes be referred to as cold liquid removal or cold oil removal when the liquid carrier 52 is an oil-based liquid.

Some example implementations of the mechanical liquid removal element 110 may comprise a squeegee 112, air knife 114 and/or other mechanical elements 116 (e.g. doctor blade) which act to mechanically move the liquid off or away from the substrate in a manner which does not disturb the ink particles 54 from their target locations on the substrate 45.

As further shown in FIG. 2, in some examples and in general terms, the liquid removal element 100 may comprise a radiation element(s) 120 to exert radiative energy toward or onto the substrate 45 to cause evaporation of the liquid carrier 52, which results in removing at least a portion 62 of liquid from substrate 45 (e.g. FIG. 1A). In some examples, the radiative element 120 may comprise an ultraviolet radiative element 122, an infrared radiative element 124, and/or a heated air element 126. In some examples, the heated air is controlled to maintain the ink particles 54, substrate 45, etc. at a temperature below 60 degrees C., which may prevent deformation of substrate 45, such as cockling, etc. In some examples, the radiative element 120 may sometimes be referred to as an energy transfer mechanism or structure by which energy is transferred to the liquid 52, ink particles 54, and substrate 45 in order to dry the ink particles 54 and/or substrate 45.

As further shown in FIG. 2, in some examples and in general terms, the liquid removal element 100 may comprise a vapor recovery element 130, which acts to recover the liquid carrier 52 when in vapor form resulting from its evaporation from application of at least one of the radiative elements 120. In some such examples, the vapor recovery element 130 may comprise a suction element 134 to apply suction or vacuum pressure to capture the vaporized liquid carrier 52. The captured vapor may be further processed into a liquid form as further shown in FIG. 3 for supply as at least a portion of the second liquid carrier 24 provided to, and at, mixer 30, as shown in FIG. 1A.

In some examples the terms “first”, “second”, “third” may sometimes be used to refer to different types (e.g. modalities) or instances of liquid removal elements without necessarily indicating an order or sequence of multiple liquid removal elements. Accordingly, by specifying that a particular liquid removal element may comprise a “second” liquid removal element, the term “second” does not necessarily indicate that a “first” liquid removal element exists and/or precedes the “second” liquid removal element. Similarly, in the context of at least FIGS. 3-6, the terms “first” and “second” with regard to conveyance pathways do not necessarily designate a sequence or number of conveyance pathways, but may simply be used to identify different types or instances of conveyance pathways.

FIG. 3 is a diagram schematically representing an example image formation device 200. In some examples, this image formation device 200 may comprise at least some of substantially the same features and attributes as the image formation device previously described in association with FIGS. 1A-2, except further comprising a more detailed arrangement 290 for providing a second liquid carrier (282A, 282B, 282C) to mixer 30.

As shown in FIG. 3, in some examples the arrangement 290 may comprise a supply of fresh liquid carrier 280, which may be provided via conveyance pathway 295 as a portion 282A of the second liquid carrier (e.g. 24 in FIG. 1A). The fresh liquid carrier 280 may sometimes be referred to as a shipment liquid carrier to refer to its origin external from the image formation device 200, such as being received first as a shipped product before being made available to the image formation device 200. For similar reasons, the first ink mixture 22 also may sometimes be referred to as a shipment ink mixture.

As further shown in FIG. 3, in some examples the arrangement 290 may comprise a liquid conveyance pathway 292 from the liquid removal element 60 to mixer 30. In some such examples, the pathway 292 comprises a filter 260 to remove contaminants, pigments, etc. from the recovered liquid (from liquid removal element 60) before providing the recovered liquid 252 as a portion 282C of the second liquid carrier 24 (FIG. 1A) to mixer 30.

As further shown in FIG. 3, in some examples the arrangement 290 may comprise a vapor conveyance pathway 294 between the liquid removal element 60 and mixer 30. In some such examples, the pathway 294 comprises a condenser 270 (e.g. air condenser) to condense the non-aqueous carrier (e.g. oil) from its vapor state (254) back to a liquid state. In addition, in some such examples, the pathway 294 comprises a filter 262 to remove any contaminants, pigments, etc. from the recovered vapor 254 (from liquid removal element 60) before providing the recovered liquid 271 as a portion 282B of the second liquid carrier 24 (FIG. 1A) to mixer 30.

It will be understood that, in some examples, an example image formation device 200 may comprise just one of the pathways (e.g. 292, 294, 295) or some combination of the respective pathways (292, 294, 295) to provide second liquid carrier (e.g. 24 in FIG. 1A) at mixer 30.

In some examples, prior to the mixer 30 receiving the second liquid carrier 24, additional components such as dispersants, binders, etc. may be added to the second liquid carrier 24. Alternatively, such components may be added to the second liquid ink mixture 26 after dilution of the first liquid ink mixture 22, but prior to reception and use at the fluid ejection device 40.

FIG. 4 is a diagram schematically representing an example image formation device 300. In some examples, this image formation device 300 may comprise at least some of substantially the same features and attributes as the image formation device previously described in association with FIGS. 1A-3, except further comprising a charge source 302 for electrostatically fixing ink particles 54 (of the deposited droplets 41) against the substrate 45. As shown in FIG. 4, in some examples this electrostatic fixation may be implemented prior to the operation of liquid removal element 60.

In particular, through further relative movement of substrate 45 (e.g. in the direction A) relative to image formation device 300, additional aspects of image formation are performed on or relative to substrate 45 following the operation of fluid ejection device 40 depicted in FIG. 1A. Accordingly, FIG. 4 depicts the operation of charge source 302 relative to substrate 45 in which the charge source 302 emits airborne charges 303 to charge the ink particles 54, as represented via the depiction in dashed lines E in FIG. 4. The charge source 302 may comprise a corona, plasma element, or other charge generating element to generate a flow of charges. The charge source 302 may sometimes be referred to as a charge source, charge generation device, and the like. The generated charges may be negative or positive as desired. In some examples, the charge source 302 comprises an ion head to produce a flow of ions as the charges. It will be understood that the term “charges” and the term “ions” may be used interchangeably to the extent that the respective “charges” or “ions” embody a negative charge or positive charge (as determined by device 302).

In the particular instance shown in FIG. 4, the emitted charges 303 can become attached to the ink particles 54 to cause all of the charged ink particles to have a particular polarity, which will be attracted to ground. In some such examples, all or substantially all of the charged ink particles 54 will have a negative charge or alternatively all or substantially all of the charged ink particles 134 will have a positive charge.

Once charged, the ink particles 54 move, via electrostatic attraction relative to the grounded substrate 45, through the liquid carrier 52 (from deposited droplets 41 of the second ink mixture 26) toward the substrate 45 until the ink particles 54 become electrostatically fixed on the substrate 45 (represented via the depiction in dashed lines F in FIG. 4), as the relative movement between the substrate 45 and image formation device 300 continues. Via this arrangement, the liquid carrier 52 (of deposited droplets 41) exhibit a supernatant relationship to the electrostatically fixed ink particles as represented via dashed box F in FIG. 4.

Given the supernatant relationship of the liquid carrier 52 relative to the electrostatically fixed ink particles 54, the liquid removal element 60 can more easily remove the excess liquid carrier without disturbing the ink particles 54 from their target locations on substrate for forming the image on substrate 45.

Via such example arrangements such as depicted in FIG. 4, the charged ink particles 54 become electrostatically fixed (e.g. pinned) on the substrate 45 in a location on the substrate 45 generally corresponding to the location (in an x-y orientation) at which they were initially received onto the substrate 45 as jetted via fluid ejection device 40 of the image formation device 300. Via such electrostatic fixation, the ink particles 54 will retain their position on substrate 45 even when other ink particles (e.g. different colors) are added later, excess liquid is physically removed, etc. It will be understood that while the ink particles 54 may retain their position on substrate 45, some amount of expansion of a dot (formed of ink particles) may occur after the ink particles 54 (within carrier fluid 52) are jetted onto substrate 45 and before they are electrostatically pinned (i.e. electrostatically fixed).

In some examples, the ground element GND may comprise an electrically conductive element in contact with a portion of the substrate 45. In some examples, the electrically conductive element may comprise a roller or plate in rolling or slidable contact, respectively, with a portion of the media. In some examples, the ground element GND is in contact with an edge or end of the media. In some examples, the electrically conductive element may take other forms, such as a brush or other structures. Accordingly, it will be understood that the ground element GND is not limited to the particular location shown throughout the various example Figures of the present disclosure.

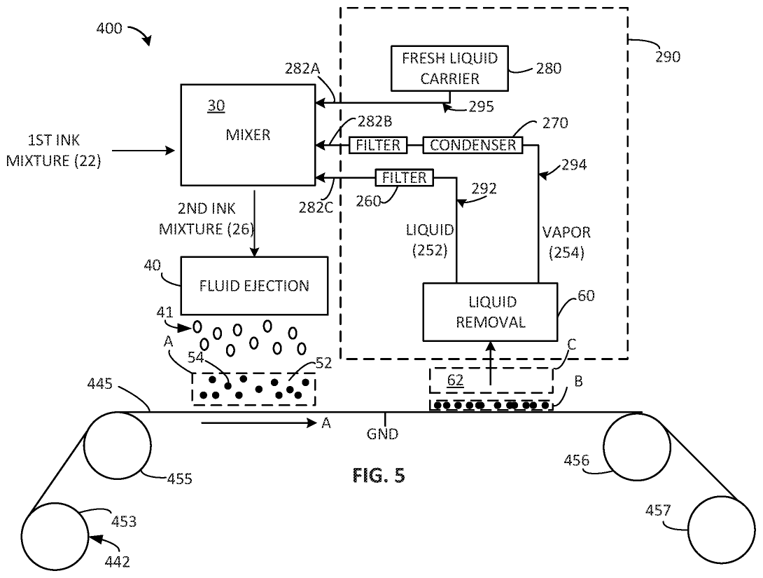

FIG. 5 is a diagram schematically representing an example image formation device 400. In some examples, this image formation device 400 may comprise at least some of substantially the same features and attributes as the image formation device previously described in association with at least FIGS. 1-4, except further comprising a substrate 445 supplied in a media roll-to-roll arrangement 442.

In this arrangement, the roll-to-roll arrangement 442 comprises a supply roll 453, support rollers 455, 456, and take-up roller 457. It will be understood that the arrangement 442 can be modified to permit additional operations on substrate 445 after support roller 456 prior to the substrate being wound up on take-up roller 457.

In comprising at least some of substantially the same features and attributes of the previous examples (FIGS. 1-4), it will be understood that some examples of image formation device 400 comprise a charge source, such as charge source 302 in FIG. 3 for inducing electrostatic migration of the ink particles 54 through the liquid carrier 52 and electrostatically fixation of the ink particles 54 relative to the substrate 445. When implemented in the example image formation device 400 of FIG. 5, the charge source 302 would be interposed at a location along the substrate 445 between the fluid ejection device 40 and the liquid removal element 60.

FIG. 6 is a diagram schematically representing an example image formation device 500. In some examples, this image formation device 500 may comprise at least some of substantially the same features and attributes as the image formation device previously described in association with FIGS. 1-4, except with substrate 545 present as a surface 507 of a rotating drum 505 of image formation device 500, as represented via directional arrow R.

In some such examples, the substrate 507 may act as an intermediate transfer member by which the ink particles 54 (FIG. 1A) are deposited onto the substrate 507 in a pattern at least partially forming an image and then later transferred onto a print medium 576, via transfer roller 570, after operation of the liquid removal element 560.

In other respects, the arrangement 290 comprises substantially the same features and attributes as the arrangement 290 previously described in association with at least FIGS. 2-5.

In comprising at least some of substantially the same features and attributes of the previous examples (FIGS. 1-5), it will be understood that some examples of image formation device 500 comprise a charge source, such as charge source 302 in FIG. 3 for inducing electrostatic migration of the ink particles 54 through the liquid carrier 52 and electrostatically fixation of the ink particles 54 relative to the substrate 507. When implemented in the example image formation device 500 of FIG. 6, the charge source 302 would be interposed at a location along drum 505 between the fluid ejection device 540 (like device 40) and the liquid removal element 560 (like element 60).

FIG. 7A is a diagram schematically representing an example image formation device 800. In some examples, the image formation device 800 may comprise at least some of substantially the same features and attributes as the image formation devices previously described in association with at least FIGS. 1A-6. Accordingly, as shown in FIG. 7A, the example image formation device 800 may comprise a liquid recovery and supply arrangement 890 having at least some of substantially the same features and attributes as arrangement 290 in FIGS. 3-6, except being shown in a simplified form in FIG. 7A for illustrative clarity. At least some aspects of the example arrangement 890 are further described below.

In some examples, the image formation device 800 shown in FIG. 7A comprises a scanning-type image formation device 800 in which a carriage 860 moves in a back-and-forth motion (as represented by directional arrows B, C) across a width (W1) of a substrate 810. In some examples, the substrate 810 may comprise a continuous sheet or web of material while in some examples, the substrate 810 may comprise a discrete print medium, such as a sheet of paper.

In some examples, the substrate 810 may comprise a cloth or textile material. In some such examples, the textile material may comprise materials such as (but not limited to) cotton, polyester, silk, and the like.

In some examples, the carriage 860 supports a fluid ejection device 40 and at least one liquid removal element 860A, 860B, like liquid removal element 60 in FIG. 1A. In some such examples, the liquid removal elements 860A, 860B may comprise at least some of substantially the same features as liquid removal element 60, 100 as previously described. The liquid removal elements 860A, 860B also may form part of the liquid recovery arrangement 890 (like 290 in FIGS. 3-6) and/or be in communication with the liquid recovery and supply arrangement 890, such as via pathways 891A, 891B, either of which may correspond to the combination of pathways 292, 294 of arrangement 290 in FIGS. 3-6.

In some examples, the image formation device 800 may comprise a second liquid removal element 870 to further remove liquids from the surface of substrate 810 after the operation of the first liquid removal element(s) 860A, 860B on the scanning carriage 850. In some examples, the second liquid removal element 870 may comprise a length L3 extending across an entire width W1 of the substrate 810 and which may be stationary relative to the advance of the print medium (as represented by directional arrow A) in the substrate advance direction A. Via this arrangement, the second liquid removal element 870 may act to further remove liquid from substrate 880 as it passes under and by the second liquid removal element 870. In some examples, the second liquid removal element 870 may comprise at least some of substantially the same features and attributes as liquid removal element 60 (FIG. 1A) and/or liquid removal element 100 in FIG. 2.

In some examples, the image formation device 800 may omit a charge source (e.g. 302 in FIG. 4), and hence does not apply charges 303 to electrostatically fix ink particles 54 of droplets 41 (of second ink mixture 26) relative to the substrate 810. In some such examples, this omission of a charge source (e.g. 302 in FIG. 4) may be implemented when the substrate 810 is a cloth or textile material.

In some examples, the respective liquid removal elements 860A, 860B, and/or 870 may omit a mechanical-type liquid removal element (e.g. 110 in FIG. 2), such as a cold liquid removal element, such that liquid removal from the substrate 810 is performed via radiative elements 120 (FIG. 2) and/or vapor recovery (e.g. 130 in FIG. 2). In some such examples, the omission of a mechanical liquid removal element may be implemented when a charge source (e.g. 302 in FIG. 4) is also omitted from image formation device 800 to help ensure that the deposited ink particles remain at their target locations in the intended pattern on substrate 810 since mechanical liquid removal might otherwise disturb such deposited ink particles 54 when not electrostatically fixed via a charge source. In some examples, the omission of both a mechanical liquid removal element and a charge source may be implemented when the substrate is a cloth or textile material at least because the cloth/textile material may comprise an absorbent material which may inhibit mechanical liquid removal. In particular, textile fabrics typically swell quickly by drawing the liquid deep inside the textile, mostly due to capillary forces. This absorption is a fast process that could take less than few milliseconds. Accordingly, mechanical liquid removal may be ineffective for some textile fabrics. In sharp contrast, when the substrate or print medium comprises a non-absorbing substrate such as polyethylene (PET), the liquid carrier may typically sit on top of substrate without being absorbed, such that the liquid carrier can easily be collected by mechanical removal element (e.g. a squeegee) if the ink particles 54 are electrostatically fixed relative to the substrate.

FIG. 7B is a diagram including a top view schematically representing an example image formation device 880. In some examples, the image formation device 880 may comprise at least some of substantially the same features and attributes as image formation device 800, except with the scanning carriage 850 further supporting a first charge source 882A and second charge source 882B, with the fluid ejection device 40 interposed between the respective charge sources 882A, 882B. Each charge source 882A, 882B may operate in substantially the same manner as previously described as charge source 302 in FIG. 4 in which charges 303 are emitted toward the substrate 810 to induce electrostatic migration of ink particles 54 though a liquid carrier 52 and electrostatic fixation (i.e. pinning) of the ink particles 54 relative to the substrate 810. Moreover, when the carriage 850 moves in a first direction C such that the first end 816A of the carriage 850 is in a leading position, the charge source 882B following the fluid ejection device 40 is in operation to cause the electrostatic fixation of the ink particles 54 with charge source 892A being inactive. Conversely, when the carriage 850 moves in an opposite second direction B such that the opposite second end 816B of the carriage 850 is in a leading position, the charge source 882A following the fluid ejection device 40 is in operation to cause the electrostatic fixation of the ink particles 54 with charge source 882B being inactive.

In some such examples, the first charge source 882A is interposed between the liquid removal element 860A and the fluid ejection device 40 while the second charge source 882B is interposed between the liquid removal element 860B and the fluid ejection device 40. However, in some examples, the liquid removal elements 860A, 860B may be omitted from carriage 850 and instead implemented elsewhere. In some such examples, the second liquid removal element 870 may comprise the sole element for removing liquid from the substrate 810 after operation of the fluid ejection device 40 as the carriage 850 moves.

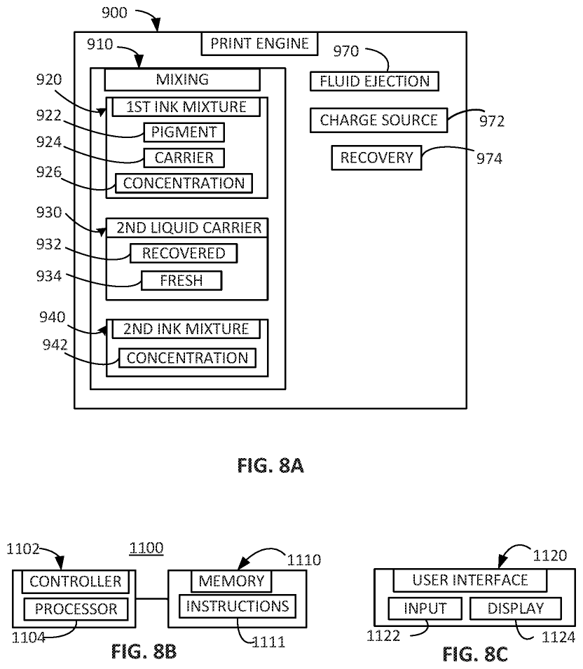

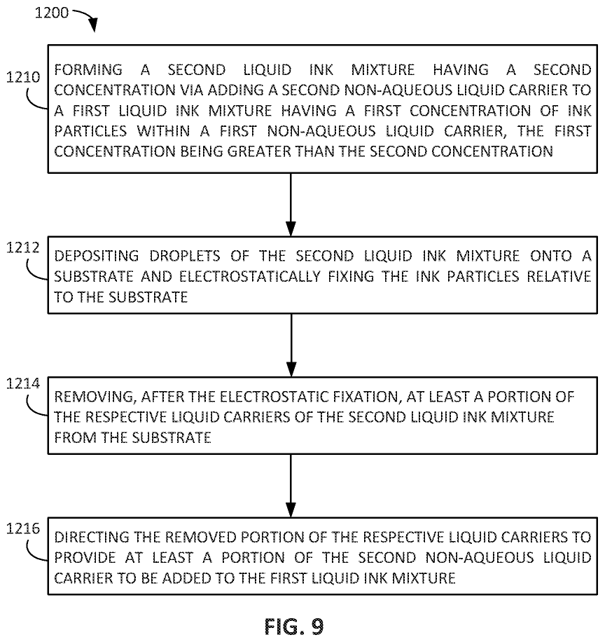

FIG. 8A is a block diagram schematically representing an example print engine 900. In some examples, the print engine 900 may form part of a control portion 1100, as later described in association with at least FIG. 8B, such as but not limited to comprising at least part of the instructions 1111. In some examples, the print engine 900 may be used to implement at least some of the various example devices and/or example methods of the present disclosure as previously described in association with FIGS. 1-7B and/or as later described in association with FIGS. 8B-9. In some examples, the print engine 900 (FIG. 8A) and/or control portion 1100 (FIG. 8B) may form part of, and/or be in communication with, an image formation device.

In general terms, the print engine 900 is to control at least some aspects of operation of the image formation devices as described in association with at least FIGS. 1A-7B and 8B-9.

As shown in FIG. 8A, the print engine 900 may comprise a mixing engine 910, a fluid ejection engine 970, a charge source engine 972, and/or a recovery engine 974. In some examples, the mixing engine 910 controls operation of mixer 30, which may comprise tracking and/or controlling various inputs and/or outputs of ink mixtures, related dilutions, and the like. In some such examples, the mixing engine 910 may comprise a first ink mixture portion 920, a second liquid carrier portion 930, and a second ink mixture portion 940.

In some such examples, the first ink mixture portion 920 may track and/or control receiving and use of a first ink mixture (e.g. 22 in FIG. 1A) via various parameters such as (but not limited to) a pigment parameter 922, liquid carrier parameter 924, and/or concentration parameter 926. Together, these parameters 922, 924, 926 enable tracking and/or control of a relative proportion of pigment (e.g. ink particles 54), liquid carrier, and/or other components (e.g. resin, binders, dispersants, etc.) in a desired concentration either prior to or after mixing and dilution with additional liquids, such as second liquid carrier (e.g. 24 in FIG. 1A; 282A-282C in FIGS. 3-6).

In some examples, the second liquid carrier portion 930 may track and/or control receiving a second liquid carrier (e.g. 24 in FIG. 1A; 282A, 282B, 282C in FIGS. 3-6). In some such examples, the second liquid carrier portion 930 may comprise a recovered liquid parameter 932 to track and/or control liquids (e.g. 282B, 282C in FIGS. 3-6) recovered via pathways 292, 294 from liquid removal element 60 with such recovered liquids entering mixer 30 to dilute the first ink mixture 22. In some such examples, the second liquid carrier portion 930 may comprise a fresh liquid parameter 934 to track and/or control liquids (e.g. 282A in FIGS. 3-6) supplied via pathway 295 and which enter mixer 30 to dilute the first ink mixture 22.

In some examples, the second liquid carrier portion 930 may manage a proportion of receipt of the recovered liquid (e.g. 282B, 282C in FIG. 3) relative to the fresh liquid carrier (e.g. 282A in FIG. 3) to achieve the targeted volume of second liquid carrier 24 to be mixed with the first ink mixture 22 in and via mixer 30. In some such examples, at least via the parameters 932, 934, the second liquid carrier portion 930 of mixing engine 910 may use just one of, or both, of the recovered liquid carrier 282B, 282C and the fresh liquid carrier 282A to be mixed with the first ink mixture 22 in mixer 30.

In some examples, the second ink mixture portion 940 may track and/or control parameters of the second ink mixture 26 exiting the mixer 30, such as but not limited to the concentration of pigments within a liquid carrier, via concentration parameter 942.

In some examples, the fluid ejection engine 970 controls operation of the fluid ejection device (e.g. 40 in FIGS. 1, 2-6) to deposit droplets of ink particles 54 within a liquid carrier 52 onto a substrate 45 (FIG. 1A) as described throughout the examples of the present disclosure.

In some examples, the charge source engine 972 controls operation of the charge source 302 to emit airborne electrical charges to induce electrostatic migration of ink particles 54 toward the substrate 45 and electrostatic fixation of the migrated ink particles 54 at their target locations in a pattern at least partially forming an image, such as described in association with FIG. 4 and/or various examples throughout the present disclosure.

In some examples, the recovery engine 974 controls operation of at least the liquid removal element 60 (FIG. 3) to remove the liquid carrier 52 from the substrate 45. Such control may comprise control of operation of at least the various elements, portions, aspects of the liquid removal element 100 in FIG. 2. Moreover, in some examples, the recovery engine 974 may control operation of at least various elements, portions, pathways (e.g. 292, 294, 295), filters, condensers, etc. of the liquid recovery arrangement 290 as described in association with at least FIGS. 3-6.

It will be understood that, in at least some examples, the print engine 900 is not strictly limited to the particular grouping of parameters, engines, functions, etc. as represented in FIG. 8A, such that the various parameters, engines, functions, etc. may operate according to different groupings than shown in FIG. 8A.

FIG. 8B is a block diagram schematically representing an example control portion 1100. In some examples, control portion 1100 provides one example implementation of a control portion forming a part of, implementing, and/or generally managing the example image formation devices, as well as the particular portions, mixers, fluid ejection devices, charge sources, liquid removal elements and related pathways, carriages, elements, devices, user interface, instructions, engines, parameters, functions, and/or methods, as described throughout examples of the present disclosure in association with FIGS. 1-8A and 8C-9.

In some examples, control portion 1100 includes a controller 1102 and a memory 1110. In general terms, controller 1102 of control portion 1100 comprises at least one processor 1104 and associated memories. The controller 1102 is electrically couplable to, and in communication with, memory 1110 to generate control signals to direct operation of at least some the image formation devices, various portions and elements of the image formation devices, such as mixers, fluid ejection devices, charge sources, liquid removal elements and related pathways, carriages, user interfaces, instructions, engines, functions, and/or methods, as described throughout examples of the present disclosure. In some examples, these generated control signals include, but are not limited to, employing instructions 1111 stored in memory 1110 to at least direct and manage depositing droplets of ink particles and carrier fluid to form an image on a media, moving a carriage, jetting droplets, directing charges onto ink particles, removing liquids, discharging a print medium, measuring potentials and/or currents, etc. as described throughout the examples of the present disclosure in association with FIGS. 1-8A and 8C-9. In some instances, the controller 1102 or control portion 1100 may sometimes be referred to as being programmed to perform the above-identified actions, functions, etc. In some examples, at least some of the stored instructions 1111 are implemented as a, or may be referred to as, a print engine, an image formation engine, and the like, such as but not limited to the print engine 900 in FIG. 8A.

In response to or based upon commands received via a user interface (e.g. user interface 1120 in FIG. 8C) and/or via machine readable instructions, controller 1102 generates control signals as described above in accordance with at least some of the examples of the present disclosure. In some examples, controller 1102 is embodied in a general purpose computing device while in some examples, controller 1102 is incorporated into or associated with at least some of the image formation devices, portions or elements along the travel path, mixers, fluid ejection devices, charge sources, liquid removal elements and related pathways, carriages, user interfaces, instructions, engines, functions, and/or methods, etc. as described throughout examples of the present disclosure.

For purposes of this application, in reference to the controller 1102, the term “processor” shall mean a presently developed or future developed processor (or processing resources) that executes machine readable instructions contained in a memory or that includes circuitry to perform computations. In some examples, execution of the machine readable instructions, such as those provided via memory 1110 of control portion 1100 cause the processor to perform the above-identified actions, such as operating controller 1102 to implement the formation of an image as generally described in (or consistent with) at least some examples of the present disclosure. The machine readable instructions may be loaded in a random access memory (RAM) for execution by the processor from their stored location in a read only memory (ROM), a mass storage device, or some other persistent storage (e.g., non-transitory tangible medium or non-volatile tangible medium), as represented by memory 1110. The machine readable instructions may include a sequence of instructions, a processor-executable machine learning model, or the like. In some examples, memory 1110 comprises a computer readable tangible medium providing non-volatile storage of the machine readable instructions executable by a process of controller 1102. In some examples, the computer readable tangible medium may sometimes be referred to as, and/or comprise at least a portion of, a computer program product. In other examples, hard wired circuitry may be used in place of or in combination with machine readable instructions to implement the functions described. For example, controller 1102 may be embodied as part of at least one application-specific integrated circuit (ASIC), at least one field-programmable gate array (FPGA), and/or the like. In at least some examples, the controller 1102 is not limited to any specific combination of hardware circuitry and machine readable instructions, nor limited to any particular source for the machine readable instructions executed by the controller 1102.

In some examples, control portion 1100 may be entirely implemented within or by a stand-alone device.

In some examples, the control portion 1100 may be partially implemented in one of the image formation devices and partially implemented in a computing resource separate from, and independent of, the image formation devices but in communication with the image formation devices. For instance, in some examples control portion 1100 may be implemented via a server accessible via the cloud and/or other network pathways. In some examples, the control portion 1100 may be distributed or apportioned among multiple devices or resources such as among a server, an image formation device, and/or a user interface.

In some examples, control portion 1100 includes, and/or is in communication with, a user interface 1120 as shown in FIG. 8C. In some examples, user interface 1120 comprises a user interface or other display that provides for the simultaneous display, activation, and/or operation of at least some of the image formation devices, portions thereof, elements, user interfaces, instructions, engines, functions, and/or methods, etc. as described in association with FIGS. 1-8B and 9. In some examples, at least some portions or aspects of the user interface 1120 are provided via a graphical user interface (GUI), and may comprise a display 1124 and input 1122.

FIG. 9 is a flow diagram schematically representing an example method. In some examples, method 1200 may be performed via at least some of the same or substantially the same image formation devices, portions, mixers, fluid ejection devices, charge sources, liquid removal elements, elements, control portion, user interface, etc. as previously described in association with FIGS. 1-8C. In some examples, method 1200 may be performed via at least some of the same or substantially the same image formation devices, portions, mixers, fluid ejection devices, charge sources, liquid removal elements, elements, control portion, user interface, etc. other than those previously described in association with FIGS. 1-8C.

As shown at 1210 in FIG. 9, method 1200 may comprise forming a second liquid ink mixture having a second concentration via adding a second non-aqueous liquid carrier to a first liquid ink mixture having a first concentration of ink particles within a first non-aqueous liquid carrier, the first concentration being greater than the second concentration. In some such examples, the first concentration may be substantially greater than the second concentration. As shown at 1212 in FIG. 9, method 1200 may further comprise depositing droplets of the second liquid ink mixture onto a substrate and electrostatically fixing the ink particles relative to the substrate. As shown at 1214, method 1200 may comprise removing, after the electrostatic fixation, at least a portion of the respective liquid carriers of the second liquid ink mixture from the substrate; and

As shown at 1216, method 1200 may comprise directing the removed portion of the respective liquid carriers to provide at least a portion of the second non-aqueous liquid carrier to be added to the first liquid ink mixture.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein.

1. An image formation device comprising:
a mixer to receive a first ink mixture of ink particles within a first non-aqueous liquid carrier in a first concentration, to receive a second non-aqueous liquid carrier, and to form a second ink mixture of the ink particles within both the first and second liquid carriers in a second concentration less than the first concentration;
a drop-on demand fluid ejection device to receive the second ink mixture and to deposit droplets of the second ink mixture onto a substrate to at least partially form an image via the ink particles; and
a liquid removal element to remove the respective liquid carriers from the substrate to provide at least a portion of the second liquid carrier at the mixer to form part of the second ink mixture.

2. The image formation device of claim 1 comprising:
a charge source to emit airborne charges to induce the ink particles of the deposited droplets to move through the respective first and second liquid carriers to become electrostatically fixed relative to the substrate.

3. The device of claim 1, wherein the liquid carrier removal device comprises:
a first liquid removal element including a mechanical structure to mechanically remove at least a portion of the respective liquid carriers from the substrate; and
a first pathway to fluidly communicate the mechanically removed portion of the respective liquid carriers from the first liquid removal element to the mixer to provide the at least a portion of the second liquid carrier at the mixer.

4. The device of claim 1, wherein the liquid carrier removal device comprises:
a second liquid removal element to evaporate at least a portion of the respective liquid carriers from the substrate, the second liquid removal element comprises at least one of an energy radiative element and a hot air flow element; and
a second pathway comprising a condenser to condense the evaporated portion of the respective liquid carriers from the second liquid removal element, wherein the second pathway is to fluidly communicate the condensed evaporated portion to the mixer to provide the at least a portion of the second liquid carrier at the mixer.

5. The device of claim 1, wherein the mixer is to receive a fresh non-aqueous liquid carrier to provide at least a portion of the second liquid carrier to form the second ink mixture.

6. The device of claim 1, wherein the substrate comprises a non-transfer media.

7. The device of claim 1, wherein the first concentration of the ink particles within the first non-aqueous liquid carrier comprises about 10 percent to about 40 percent solids by weight in a non-paste, liquid suspension.

8. The device of claim 1, wherein the first portion is to form the mixture via at least one of:
without mechanical-shear-based mixing;
without deagglomeration of the ink particles;
without a low-high-low concentration cycle; and
via energy less than 10 J/milliliter.

9. A device comprising:
a mixer to receive a non-paste ink mixture of ink particles suspended within a first oil-based liquid carrier in a first concentration and to dilute the non-paste ink mixture with a second oil-based liquid carrier to lower the first concentration of the non-paste ink mixture to a second concentration which is at least 50 percent less concentrated than the first concentration;
a fluid ejection device to deposit droplets of the diluted non-paste ink mixture onto a substrate;
a charge source to emit airborne charges to induce the ink particles, via electrostatic attraction relative to the substrate, to move through the respective liquid carriers of the diluted ink mixture to become electrostatically fixed relative to the substrate; and
a liquid removal element to remove at least a portion of the respective liquid carriers from the substrate; and
a fluid pathway to fluidly communicate the removed respective liquid carriers from the liquid removal element to the mixer to provide at least a portion of the second liquid carrier at the mixer.

10. The device of claim 9, wherein the liquid carrier removal element comprises:
a first liquid removal portion including a mechanical structure to mechanically remove at least a portion of the respective liquid carriers from the substrate; and
a second liquid removal portion including at least one of an energy radiative element and a heated air element to evaporate at least a portion of the respective liquid carriers from the substrate.

11. The device of claim 10, comprising:
a conveyance arrangement including:
a first pathway to communicate the mechanically removed portion of the respective liquid carriers from the first liquid removal portion to the mixer to provide the at least a portion of the second liquid carrier at the mixer; and
a second pathway comprising a condenser to condense the evaporated portion of the respective liquid carriers from the second liquid removal portion, wherein the second pathway is to fluidly communicate the condensed evaporated portion to the mixer to provide the at least a portion of the second liquid carrier at the mixer.

12. A method comprising:
forming a second liquid ink mixture having a second concentration via adding a second non-aqueous liquid carrier to a first liquid ink mixture having a first concentration of ink particles within a first non-aqueous liquid carrier, the first concentration being substantially greater than the second concentration;
depositing droplets of the second liquid ink mixture onto a substrate and electrostatically fixing the ink particles relative to the substrate;
removing, after the electrostatic fixation, at least a portion of the respective liquid carriers of the second liquid ink mixture from the substrate; and
directing the removed portion of the respective liquid carriers to provide at least a portion of the second non-aqueous liquid carrier to be added to the first liquid ink mixture.

13. The method of claim 12, wherein the removing of the at least a portion of the respective liquid carriers comprises:
mechanically removing a first portion of the respective liquid carriers from the substrate; and
evaporatively removing a second portion of the respective liquid carriers from the substrate as a vapor.

14. The method of claim 13, wherein the directing comprises:
conveying, via a first fluid pathway, the mechanically removed first portion of the respective liquid carriers away from the substrate to provide at least a portion of the second liquid carrier; and
condensing the vapor and conveying, via a second fluid pathway, the condensed vapor to provide at least a portion of the second liquid carrier.

15. The method of claim 14, comprising:
receiving a fresh non-aqueous liquid carrier to provide at least a portion of the second liquid carrier to form the second liquid ink mixture.
